(19) United States
(12) Patent Application Publication
(10) Pub. No.: US 2007/0272834 A1
(43) Pub. Date: Nov. 29, 2007

(54) OPTICAL MODULE

(75) Inventor: Kimio Nagasaka, Hokuto-shi (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/751,779

(22) Filed: May 22, 2007

(30) Foreign Application Priority Data
May 23, 2006 (JP) 2006-142408
Feb. 27, 2007 (JP) 2007-047251

(51) Int. Cl. H01J 3/14; H01J 40/14

(52) U.S. Cl. 250/216

(57) ABSTRACT

An optical module includes: a light emitting element; an optical member having a first lens surface that focuses light emitted from the light emitting element, a reflection surface that reflects a part of the light and passes another part of the light focused by the first lens surface, and a refracting surface that refracts the light reflected by the reflection surface; and a photodetector element that receives the light passed through the refracting surface, wherein the first lens surface and the refracting surface are defined by a coaxial surface of revolution, the first lens surface has a protruded section at a center section thereof, and the refracting surface is formed in a region that surrounds the first lens surface in a plan view.

The entire disclosure of Japanese Patent Application Nos: 2006-142408, dilled May 23, 2006 and 2007-047251, filed Feb. 27, 2007 are expressly incorporated by reference herein.

### BACKGROUND

1. Technical Field

The present invention relates to optical modules.

2. Related Art

A light emitting element such as a surface-emitting type laser has characteristics in which its light output changes depending on the surrounding conditions such as the ambient temperature. For this reason, an optical module that uses a light emitting element may be equipped with a photodetector element having a light detecting function to detect a part of laser light emitted from the light emitting element to thereby monitor its light output value. In order to conduct a part of laser light emitted from the light emitting element to the photodetecting element, an optical member having a structure equipped with a plurality of lenses and reflection surfaces may be needed. However, in order to manufacture an optical module including such optical members, a plurality of optical members not only need to be prepared, but also its manufacturing process becomes complex. In this respect, Japanese laid-open patent application JP-A-2004-319877 may be an example of related art.

### SUMMARY

In accordance with an advantage of some aspects of the present invention, there is provided an optical module by which its manufacturing process can be simplified.

An optical module in accordance with an embodiment of the invention includes a light emitting element; an optical member having a first lens surface that focuses light emitted from the light emitting element, a reflection surface that reflects a part of the light and transmits another part of the light focused by the first lens surface, and a refracting surface that refracts the light reflected by the reflection surface; and a photodetector element that receives the light passed through the refracting surface, wherein the first lens surface and the refracting surface are defined by a coaxial surface of revolution, the first lens surface has a protruded section at a center section thereof, and the refracting surface is formed in a region that surrounds the first lens surface in a plan view.

In the optical module in accordance with an aspect of the present embodiment, the optical member has the first lens surface and the refracting surface formed from a coaxial surface of revolution such that the process for manufacturing optical members can be simplified.

In the optical module in accordance with an aspect of the present embodiment, the refracting surface may function as a second lens surface that focuses the light reflected by the reflection surface.

In the optical module in accordance with an aspect of the present embodiment, the refracting surface may have a shape that conforms to a side surface of a cone.

In the optical module in accordance with an aspect of the present embodiment, the optical member may further include a third lens surface that focuses the light passed through the reflection surface.

In the optical module in accordance with an aspect of the present embodiment, the optical member may further include a sleeve that supports an optical fiber for incidence of the light focused by the third lens surface.

In the optical module in accordance with an aspect of the present embodiment, the light emitting element and the photodetector element may be formed on a common substrate.

In the optical module in accordance with an aspect of the present embodiment, the refracting surface may be adjacent to an outer circumference of the first lens surface.

In the optical module in accordance with an aspect of the present embodiment, an optical axis of the light that passes the first lens surface may be different from an optical axis of the light that passes the refracting surface.

In the optical module in accordance with an aspect of the present embodiment, the first lens surface may be in a circular shape as viewed in a plan view.

In the optical module in accordance with an aspect of the present embodiment, the optical member may have a concave section provided between the first lens surface and the reflection surface in a generally orthogonal direction with respect to an optical axis of the light emitted from the light emitting element.

In the optical module in accordance with an aspect of the present embodiment, the reflection surface may form an inner wall of the concave section.

In the optical module in accordance with an aspect of the present embodiment, the inner wall of the concave section may be formed from a bottom section, the reflection surface and a transmission surface opposite to the reflection surface, wherein a gap between the reflection surface and the transmission surface becomes wider, as the gap is removed away from the bottom section.

In the optical module in accordance with an aspect of the present embodiment, the transmission surface may not be orthogonal to the optical axis of the light emitted from the light emitting element.

In other words, the transmission surface may have an angle less than 90 degrees with respect to the optical axis of the light emitted from the light emitting element, or may have an angle greater than 90 degrees with respect to the optical axis of the light emitted from the light emitting element.

In the optical module in accordance with an aspect of the present embodiment, the photodetector element may have a function to monitor an output of light generated by the light emitting element, wherein a current to be supplied to the light emitting element may be adjusted based on the output of the light monitored by the photodetector element.

### BRIEF DESCRIPTION OF THE DRAWINGS

FIG. 1 is a schematic cross-sectional view of an optical module in accordance with an embodiment of the invention.

FIG. 2 is a schematic side view of the optical module in accordance with the embodiment.

FIG. 3 is a cross-sectional view schematically showing in enlargement of a portion of the optical module in accordance with the embodiment.

FIG. 4 is a schematic plan view of the optical module in accordance with the embodiment.

FIG. 5 is a cross-sectional view schematically showing in enlargement of a portion of the optical module in accordance with the embodiment.

FIG. 6 is a schematic cross-sectional view of an optical module in accordance with a first modified example.

FIG. 7 is a schematic cross-sectional view of an optical module in accordance with a second modified example.

FIG. 8 is a schematic cross-sectional view of an optical module in accordance with a third modified example.

### DESCRIPTION OF EXEMPLARY EMBODIMENTS

Preferred embodiments of the invention are described below with reference to the accompanying drawings.

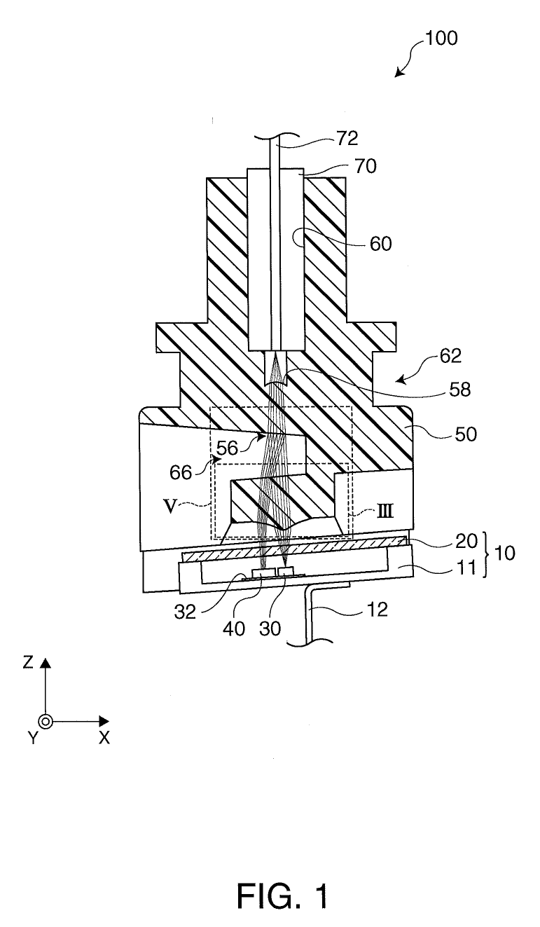

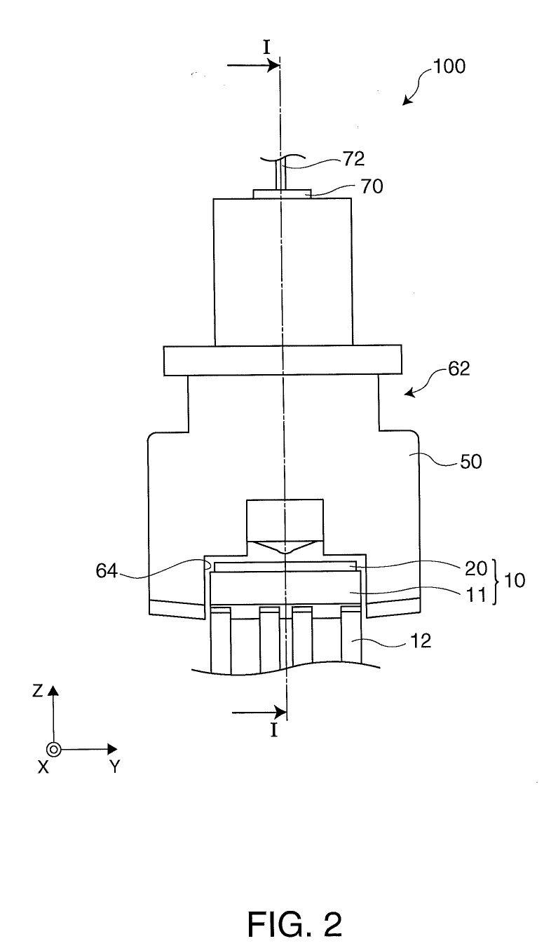

FIG. 1 is a schematic cross-sectional view of an optical module 100 in accordance with an embodiment of the present invention. FIG. 2 is a schematic side view of the optical module 100 in accordance with the present embodiment. FIG. 1 is a view showing a cross section taken along a line I-I in FIG. 2.

The optical module 100 includes a light emitting element 30, a connector with lens 50 that is an example of an optical member, a photodetector element 40, and a package 10.

The light emitting element 30 emits laser light. The light emitting element 30 may be, for example, a surface-emitting type semiconductor laser. The light emitting element 30 is provided inside the package 10 to be described below. The photodetector element 40 may only need to convert the received light into a current, and may be, for example, a pin photodiode. The photodetector element 40 is provided inside the package 10, and may be provided on a common surface on which the light emitting element 30 is provided. In accordance with the present embodiment, the photodetector element 40 is provided on a common substrate 32 on which the light emitting element 30 is provided. The substrate 32 is provided with wirings that electrically connect the light emitting element 30 and the photodetector element with lead wires 12, respectively.

The light output of the light emitting element 30 is mainly decided by a bias voltage that is applied to the light emitting element 30. In particular, the light output of the light emitting element 30 considerably changes according to the ambient temperature of the light emitting element 30 and the service life of the light emitting element 30. Therefore, it is necessary to maintain the light output of the light emitting element 30 at a predetermined level.

Accordingly, in the optical module 100 in accordance with the present embodiment, the light output of the light emitting element 30 is monitored, and a voltage value to be applied to the light emitting element 30 is adjusted based on the value of a current generated at the light emitting element 40. By this, the value of a current flowing within the light emitting element 30 can be adjusted, and the light output of the light emitting element 30 can be maintained at a predetermined level. The control to feed back the light output of the light emitting element 30 to the value of a voltage to be applied to the light emitting element 30 can be performed with an external electronic circuit (for example, a driver circuit not shown) electrically connected to the lead wires 12.

In other words, the photodetector element 40 can monitor the light output of the light emitting element 30 by converting the light generated at the light emitting element 30 into a current. More concretely, the photodetector element 40 absorbs a part of the light generated by the light emitting element 30, and the absorbed light causes photoexcitation, whereby electrons and holes are generated. Then, upon application of an electric field applied from outside the device, the electrons and the holes migrate to the electrodes, respectively, converting them into a current. The external electronic circuit can decides a voltage value to be applied to the light emitting element 30 based on the current value. In this manner, the photodetector element 40 always monitors the light output of the light emitting element 30, whereby the light emitting element 30 can maintain the light output at a predetermined level.

The package 10 seals the light emitting element 30 and the photodetector element 40. The package 10 includes a housing 11 and a lid member 20. The material of the housing 11 is not particularly limited, and may be formed from ceramics or metal. Also, the housing 11 is provided with wirings for electrically connecting the light emitting element 30 and the photodetector element 40 with lead wires 12 (not shown). The wirings are continuously formed from the upper surface to the lower surface of the housing 11.

The lid member 20 is provided in a manner to cover an opening section surrounding the frame portion of the housing 11, and may be affixed to the housing by adhesive. The lid member 20 may be formed from a transparent substrate that transmits light emitted from the light emitting element 30 or light to be received, and may be formed from a glass substrate.

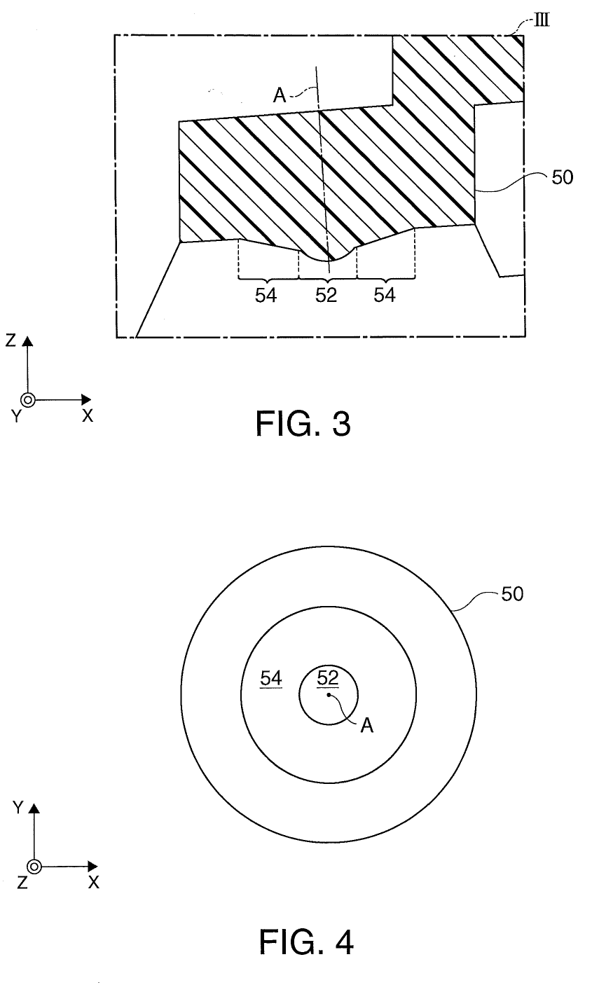

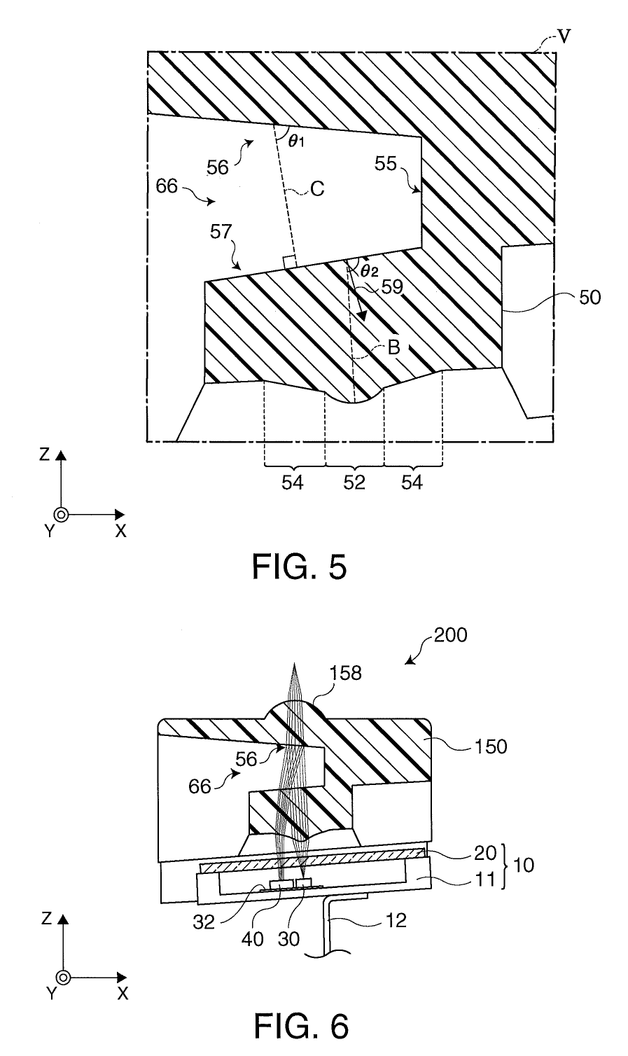

Next, the connector with lens 50 is described in detail with reference to FIGS. 1-5. FIG. 3. FIG. 3 is a view in enlargement of an area III indicated in FIG. 1. FIG. 4 is a plan view of the connector with lens 50 shown in FIG. 3 as viewed from the side of the light emitting element 30 (from the downside). FIG. 5 is a view in enlargement of an area V indicated in FIG. 1. The connector with lens 50 has a first lens surface 52, a reflection surface 56, a refracting surface (second lens surface) 54, and a third lens surface 58.

The first lens surface 52 focuses light emitted from the light emitting element 30. The first lens surface 52 is formed from an aspheric lens having a convex section at its center, and has a collimating function. In other words, the first lens surface 52 is capable of converting divergent light emitted from the light emitting element 30 into parallel light or focused light, as shown in FIG. 1. The first lens surface 52 is disposed on a light path of laser light emitted from the light emitting element 30, in other words, above the light emitting element 30. The first lens surface 52 is defined by a surface of revolution that is formed by revolving a curve about a linear line A as an axis, and has a circular shape as viewed in a plan view, as shown in FIG. 3 and FIG. 4.

The reflection surface 56 reflects a part of light focused by the first lens surface 52, and transmits the other part thereof. In other words, the reflection surface 56 has a function as a half-mirror. The ratio between transmission and reflection is not particularly limited, but the rate of transmission may preferably be larger, and the rate of reflection may be about several %. A gap is present between the reflection surface 56 and the first lens surface 52. Because the gap and the connector with lens 50 have different indexes of refraction, light can be reflected by the reflection surface 56.

The refracting surface 54 transmits light reflected by the reflection surface 56. Also, the refracting surface 54 may focuses light reflected by the reflection surface 56. The refracting surface 54 may be provided around the first lens surface 52, and its configuration may be in an annular shape as viewed in a plan view, and may be a surface of revolution that is formed by revolving a linear line or a curve about the linear line A as an axis, as shown in FIG. 3 and FIG. 4. The refracting surface 54 is not particularly limited to any configuration as long as light reflected by the reflecting surface 56 enters the photodetector element 40, and does not enter the light emitting element 30, and may be, for example, in a configuration of the side surface of a cone. When the refracting surface 54 has such a configuration, light can be focused in a circumferential direction of a cone, and the monitoring accuracy of the photodetector element 40 can be improved.

The third lens surface 58 focuses light that has passed through the reflection surface 56. More concretely, the third lens surface 58 focuses light that has passed through the reflection surface 56 so that the light is converged at the bottom surface of the sleeve 60 (at an end section of an optical fiber 72). By this, the optical coupling efficiency between the light emitting element 30 and an optical fiber 72 to be described below can be improved.

The connector with lens 50 further includes a sleeve 60. The sleeve 60 is provided at a position opposite to the third lens surface 58, and supports the optical fiber 72. The sleeve 60 can be formed, for example, along an optical axis direction, and can support the optical fiber 72 when a ferule 70 is inserted in the sleeve 60.

The connector with lens 50 further includes a first concave section 64. The first concave section 64 is provided in an opposite direction at a position opposite to the sleeve 60. The package 10 is disposed inside the first concave section 64, whereby the package 10 is fitted in the connector with lens 50. The package 10 may be affixed by coating an adhesive or the like on the inner wall of the first concave section 64. The first concave section 64 has a plane configuration that conforms to the side surface of the package 10, and may be, for example, a rectangle.

The connector with lens 50 further includes a second concave section 62. The second concave section 62 is formed in a direction generally orthogonal to the optical axis, and at the side surface of the connector with lens 50. The second concave section 62 may preferably be provided at a position symmetrical with respect to the optical axis. By this, during or after manufacturing the optical module 100, a retaining member can hold the connector with lens 50 at the second concave section 62.

The connector with lens 50 further includes a third concave section 66. The third concave section 66 is provided between the first lens surface 52 and the reflection surface 56. The third concave section 66 extends in a direction generally orthogonal to the optical axis, and is provided in a manner that light can pass inside the third concave section 66. A portion of the inner wall of the third concave section 66 can function as the reflection surface 56. In other words, the reflection surface 56 can form a portion of the inner wall of the third concave section 66. By this, an interface between the resin material of the connector with lens 50 and air can be functioned as the reflection surface 56.

More concretely, the inner wall of the concave section 66 is formed from the reflection surface 56, a bottom section 55, and a transmission surface 57 opposite to the reflection surface 56. The reflection surface 56 and the transmission surface 57 are formed opposite to each other in a manner that, the farther the gap between them away from the bottom section 55, the wider the gap becomes. In other words, as shown in FIG. 5, the angle θ₁ defined between a line C perpendicular to the transmission surface 57 and the reflection surface 56 can be less than 90°. By this, for example, when the connector with lens 50 is fabricated with a metal mold, the connector with lens 50 can be readily pulled out from the metal mold. Also, because the transmission surface 57 is provided at an interface between the resin material of the connector with lens 50 and air, the transmission surface 57 reflects a part of light focused by the first lens surface 52, and transmits the other part, like the reflection surface 56. The ratio between transmission and reflection is not particularly limited, but the rate of transmission may preferably be greater; and the lower the rate of reflection, the better. The transmission surface 57 may define an angle θ₂ with respect to an optical axis B of light focused by the first lens surface 52, wherein the angle θ₂ may not preferably be 90°, and may be, for example, greater than 90°, as shown in FIG. 5. When the angle θ₂ is not 90°, light 59 reflected at the transmission surface 57 can be prevented from returning to the light emitting element 30. Also, when the angle θ₂ is greater than 90°, light 59 reflected at the transmission surface 57 is directed to the opposite side of the photodetector element 40, such that the light 59 can be prevented from entering the photodetector element 40.

The connector with lens 50 includes the first lens surface 52, the reflection surface 56, the refracting surface 54, the third lens surface 58, the sleeve 60, the first concave section 64, the second concave section 62 and the third concave section 66 formed in one piece. The connector with lens 50 may be composed of resin material. As the resin material, a material that is capable of transmitting light may be selected. For example, polymethyl methacrylate (PMMA), epoxy resin, phenol resin, diallylphthalate, phenyl methacrylate, fluorine type polymer, polyether imide (PEI) and the like can be used.

According to the optical module 100 in accordance with the present embodiment, the connector with lens 50 has the first lens surface 52, the reflection surface 56 and the refracting surface 54 formed in one piece, such that, only by mounting the connector with lens 50 on the light emitting element 30 and the photodetector element 40, the photodetector element 40 can monitor light emitted from the light emitting element 30 without providing a half-mirror or the like on the package 10.

Also, according to the optical module 100 in accordance with the present embodiment, the refracting surface 54 is provided adjacent to the outer circumference of the first lens surface 52. By this, the light emitting element 30 and the photodetecting element 40 can be disposed adjacent to each other. Also, light can be made incident upon the reflection surface 56 in a direction generally perpendicular to the reflection surface 56, such that the polarization dependency of light in reflection can be reduced. Accordingly, the monitoring accuracy of the photodetector element 40 can be improved, and the reliability of the optical module 100 can accordingly be improved.

Also, according to the optical module 100 in accordance with the present embodiment, the first lens surface 52 and the refracting surface 54 are defined by a coaxial surface of revolution. By this, a metal mold that is used for forming the connector with lens 50 can be manufactured in a single cutting process, and therefore the manufacturing process can be simplified.

Next, a first modified example of the present embodiment is described. FIG. 6 is a cross-sectional view schematically showing an optical module 200 in accordance with the first modified example, and corresponds to FIG. 1.

The optical module 200 in accordance with the first modified example is different from the optical module 100 in accordance with the embodiment described above in that the configuration of its connector with lens is different from that of the present embodiment. More concretely, a connector with lens 150 of the optical module 200 is different from the connector with lens 50 in that it does not have a sleeve for inserting a ferule or the like.

Further, the connector with lens 150 in accordance with the first modified example has a fourth lens surface 158 instead of the third lens surface 58. The fourth lens surface 158 is capable of focusing light that has passed through the reflection surface 56, like the third lens surface 58.

Other portions of the structure of the optical module 200 are substantially the same as those of the structure of the optical module 100 described above, and therefore their description is omitted.

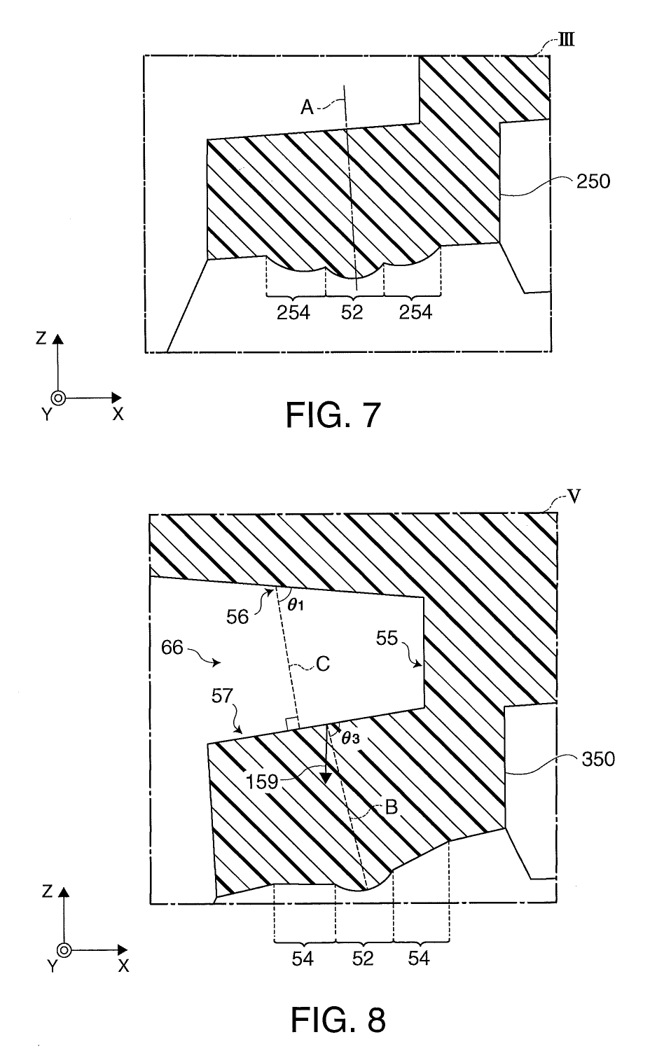

Next, a second modified example of the present embodiment is described. FIG. 7 is a cross-sectional view of a connector with lens 250 in accordance with the second modified example, and corresponds to FIG. 3. The connector with lens 250 in accordance with the second modified example is different from the connector with lens 50 of the present embodiment in that the configuration of its refracting surface 254 is not in a shape of the side surface of a cone. The refracting surface 54 of the connector with lens 50 shown in FIG. 3 is defined by a surface of revolution that is formed by rotating a linear line about the linear line A as an axis. However, the refracting surface 254 of the connector with lens 250 shown in FIG. 7 is defined by a surface of revolution that is formed by rotating a curve about the linear line A as an axis. Also, as shown in FIG. 7, the refracting surface 254 has a gentle convex configuration, and therefore is capable of focusing light not only in a circumferential direction, but also in a direction perpendicular to the circumference.

Other portions of the structure of the connector with lens 250 are substantially the same as those of the structure of the connector with lens 50 described above, and therefore their description is omitted.

Next, a third modified example of the present embodiment is described. FIG. 8 is a cross-sectional view of a connector with lens 350 in accordance with the third modified example, and corresponds to FIG. 5. The connector with lens 350 in accordance with the third modified example is different from the connector with lens 50 of the present embodiment in that the angle θ₃ defined between the transmission surface 57 and an optical axis B of light focused by the first lens surface 52 is less than 90°.

The invention is not limited to the embodiments described above, and many modifications can be made. For example, the invention may include compositions that are substantially the same as the compositions described in the embodiments (for example, a composition with the same function, method and result, or a composition with the same objects and result). Also, the invention includes compositions in which portions not essential in the compositions described in the embodiments are replaced with others. Also, the invention includes compositions that achieve the same functions and effects or achieve the same objects of those of the compositions described in the embodiments. Furthermore, the invention includes compositions that include publicly known technology added to the compositions described in the embodiments.

What is claimed is:

1. An optical module comprising:
a light emitting element;
an optical member having a first lens surface that focuses light emitted from the light emitting element, a reflection surface that reflects a part of the light and transmits another part of the light focused by the first lens surface, and a refracting surface that refracts the light reflected by the reflection surface; and
a photodetector element that receives the light passed through the refracting surface,
wherein the first lens surface and the refracting surface are defined by a coaxial surface of revolution, the first lens surface has a protruded section at a center section thereof, and the refracting surface is formed in a region that surrounds the first lens surface in a plan view.

2. An optical module according to claim 1, wherein the refracting surface functions as a second lens surface that focuses the light reflected by the reflection surface.

3. An optical module according to claim 1, wherein the refracting surface has a shape that conforms to a side surface of a cone.

4. An optical module according to claim 1, wherein the optical member further includes a third lens surface that focuses the light passed through the reflection surface.

5. An optical module according to claim 5, wherein the optical member further includes a sleeve that supports an optical fiber for incidence of the light focused by the third lens surface.

6. An optical module according to claim 1, wherein the light emitting element and the photodetector element are formed on a common substrate.

7. An optical module according to claim 1, wherein the refracting surface is adjacent to an outer circumference of the first lens surface.

8. An optical module according to claim 1, wherein an optical axis of the light that passes the first lens surface is different from an optical axis of the light that passes the refracting surface.

9. An optical module according to claim 1, wherein the first lens surface is in a circular shape as viewed in a plan view.

10. An optical module according to claim 1, wherein the optical member has a concave section provided between the first lens surface and the reflection surface in a generally orthogonal direction with respect to an optical axis of the light emitted from the light emitting element.

11. An optical module according to claim 10, wherein the reflection surface forms an inner wall of the concave section.

12. An optical module according to claim 11, wherein the inner wall of the concave section is formed from a bottom section, the reflection surface and a transmission surface opposite to the reflection surface, wherein a gap between the reflection surface and the transmission surface becomes wider, as the gap is removed away from the bottom section.

13. An optical module according to claim 12, wherein the transmission surface has an angle less than 90 degrees with respect to the optical axis of the light emitted from the light emitting element.

14. An optical module according to claim 12, wherein the transmission surface has an angle greater than 90 degrees with respect to the optical axis of the light emitted from the light emitting element.

15. An optical module according to claim 1, wherein the photodetector element has a function to monitor an output of light generated by the light emitting element, wherein a current to be supplied to the light emitting element is adjusted based on the output of the light monitored by the photodetector element.
